(19) United States
(12) Patent Application Publication
(10) Pub. No.: US 2014/0109137 A1
(43) Pub. Date: Apr. 17, 2014

(54) METHOD AND APPARATUS FOR USER INTERACTION WITH PROGRAMS UTILIZING CLOSED CAPTIONING DATA CONTENT

(71) Applicants: FAISAL MUSHTAQ, San Diego, CA (US); Kashif Jamil, Missassauga (CA); Sohail Aboobaker, Toronto (CA)

(72) Inventors: FAISAL MUSHTAQ, San Diego, CA (US); Kashif Jamil, Missassauga (CA); Sohail Aboobaker, Toronto (CA)

(21) Appl. No.: 13/650,015

(22) Filed: Oct. 11, 2012

(51) Int. Cl. H04N 21/431

(52) U.S. Cl. CPC H04N 21/4312
USPC 725/37

(57) ABSTRACT

An apparatus and method decode and read text embodied in a closed captioning signal. A rules based processor identifies subject matter included in the closed captioning text. This subject matter is context-searched to derive search terms to access information relevant to the subject matter, generally from a remote location. Selections made from accessed information are made. The selections are the basis from which choices are constructed to present to a user via, e.g., a graphical user interface (GUI). The user may interact with the GUI to make a selection. Selections may include accessing a URL for information related to the subject matter or accessing an e-commerce site that offers goods related to the subject matter. The GUI facilitates further interaction in order to allow the user to select further options which are dependent from the initial selection.

### CROSS-REFERENCE TO RELATED APPLICATIONS

This application claims priority from provisional application Ser. No. 61/546,079, entitled “Method And Apparatus For Interactive And Context Aware Television Experience Based On Closed Caption,” filed on Oct. 12, 2011. The contents of this provisional application are fully incorporated herein by reference.

### BACKGROUND

1. Field

The present subject matter relates to a method and apparatus for extracting data included in a video signal stream and generating options with which a user may interact based on contextual searching of the data.

2. Background in the Art

Closed captioning data contains a continuously updated text resembling a transcript of a current television program. Closed captioning data was originally intended for use only by hearing impaired television viewers. The closed captioning data is transmitted during a vertical blanking period of a raster scan when video image data is not being received. During this period, the scan is prepared to define a next line of video data. New uses have been found for the closed captioning data signals separate from providing signals from which text display is derived.

Use of closed captioning information for a separate purpose is shown in United States Published Patent Application No. 20060215991. A television recorder reads a closed captioning data from a current program and stores it. The recorder also reads subsequent information. For comparison to the first set of data so that it can detect a duplicate program and avoid making a duplicate recording. This system does not provide information which is provided directly to a viewer.

### SUMMARY

Briefly stated, in accordance with the present subject matter, an apparatus and method are provided in which text embodied in a closed captioning signal is decoded and read by a rules based processor in order to identify subject matter included in the closed captioning text. This subject matter is context-searched to derive search terms to access information relevant to the subject matter, generally from a remote location. Selections made from accessed information are made. The selections are the basis from which choices are constructed to present to a user via, e.g., a graphical user interface (GUI). The user may interact with the GUI to make a selection. Selections may include accessing a URL for information related to the subject matter or accessing an e-commerce site that offers goods related to the subject matter. The GUI facilitates further interaction in order to allow the user to select further options which are dependent from the initial selection.

### BRIEF DESCRIPTION OF THE DRAWINGS

FIG. 1 is a block diagram of a system in which the present subject matter is employed;

FIG. 2 is a chart indicating content included in a nominal closed captioning data stream;

FIG. 3 is a chart of selected terms comprising data that may be derived from the content in FIG. 2;

FIG. 4 is a chart illustrating searching that may be performed on the data illustrated in FIG. 3;

FIG. 5 is a chart illustrating choices that may be provided to a user based on data obtained in response to searching;

FIG. 6 is a diagram illustrating a graphical user interface from which a user may make selections;

FIG. 7 is a diagram illustrating a response to a selection by a user of one alternative of the display in FIG. 6;

FIG. 8 is a flowchart illustrating operation of the content processor in the system of FIG. 1;

FIG. 9 is block diagram illustrating interaction of the remote control unit in greater detail; and

FIG. 10 is a block diagram illustrating a further implementation of the present subject matter.

### DETAILED DESCRIPTION

The present subject matter comprises a method and apparatus which enable a user to interact with a communications system to produce results that are relevant to the subject matter of a current program. A system reads and analyzes closed captioning data in order to provide displays of data which may be presented via a graphical user interface (GUI) to a user on a screen on which the user is viewing a current program. The user may make various selections. Examples of selections available through the GUI include links to Internet sources. The screen display may also give the opportunity to the user to make choices. Links may link to websites in order to place an order to buy a product or service associated with program intelligence embodied in the closed captioning signals. The system and the GUI may allow further selections of options regarding an initial selection.

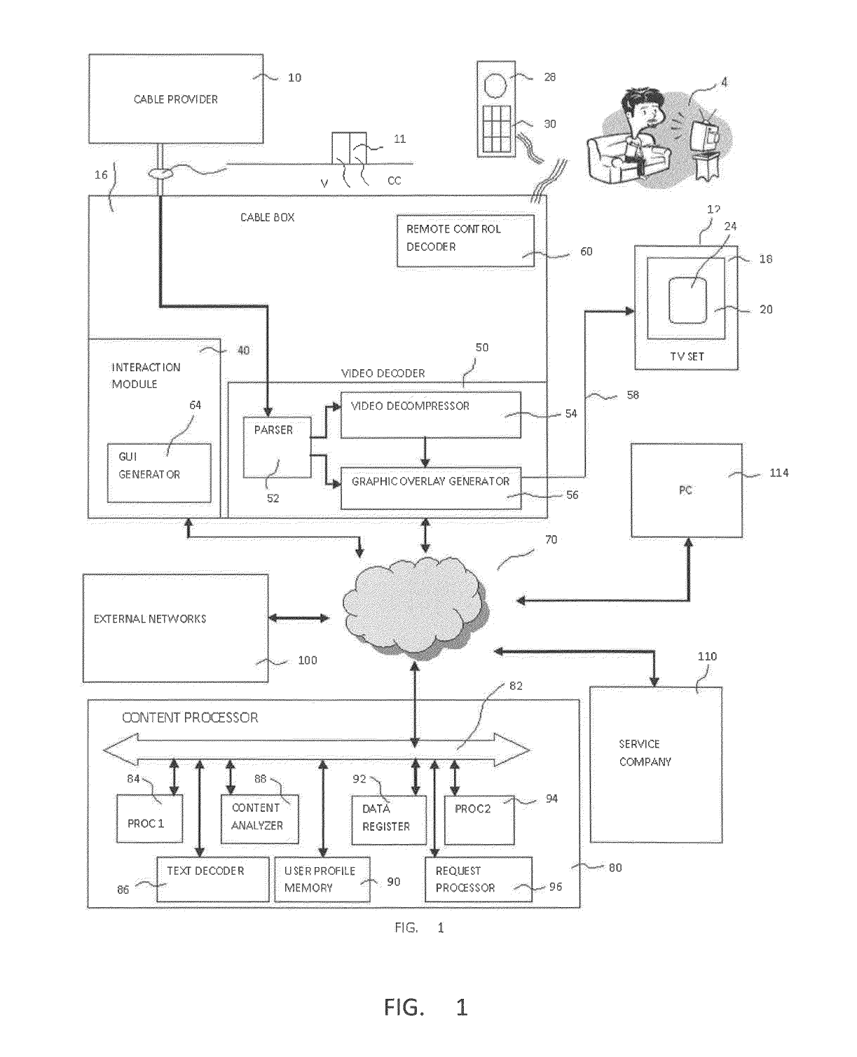

FIG. 1 is a block diagram of a system 1 which uses closed captioning signals included in a television signal. Television signals are provided from a source such as a cable provider 10. The cable provider 10 transmits a video signal 11. The video signal 11 includes a video data signal V and a closed captioning data signal CC. In standard television protocols, the signal CC is transmitted during the time period when video information is not transmitted. This time period is the vertical blanking interval when a raster scan moves from a first line to a next line. The video signal 11 is provided to a cable box 16. In the present description, “cable box” is a term describing a device for decoding a video signal and providing it to a media device 12. The term “cable box” is used since this describes an apparatus with a well-known function with many possible well-known structures. Alternative embodiments for providing a video signal to a media device 12 are further described below.

The media device 12 is a device for viewing of a program by a user 4. The user 4 commonly comprises a person viewing the media device 12. The media device 12 may comprise any of a number of various forms of receivers that exist today. With the convergence of communications devices and media devices, it is likely that there will be equivalent devices that do not yet exist. Examples of current media devices 12 include a television set 18 receiving signals directly from the cable box 16. The television set 18 comprises a display 20. As further described below, a graphical user interface 24 may selectively be provided on the display 20. The cable box 16 preferably works in conjunction with a remote control unit 28 operated by the user 4.

In accordance with the present subject matter, and interaction module 40 is provided for operation in conjunction with the cable box 16. The interaction module 40 may comprise a separate set-top box. Alternatively, the interaction module 40 may be included as a component of a modified version of a conventional cable box 16. The cable box 16 comprises a video decoder 50, which provides signals to drive the display 20 and present the program via the television set 18. In many common cases, the video decoder 50 may be included in the television set 18. In FIG. 1, the video decoder 50 is shown as being in the cable box 16 for convenience. Locating the video decoder 50 in a particular module is not essential. In the video decoder 50, the video signal 11 is connected to a signal parser 52, which separates the video components from the closed captioning component CC. The video signal V is connected to a video decompressor 54, and the closed captioning signal CC is connected to a graphics overlay generator 56. An output of the video decompressor 54 is connected to a second input of the graphics overlay generator 56. The graphics overlay generator 56 translates the closed captioning signal CC and combines text with the video signal to provide an output at a terminal 58 coupled to drive the display 20.

The signal parser 52 provides the closed captioning signal CC to the interaction module 40 as well. The cable box 16 includes a remote control decoder 60 for responding to signals from the user 4's remote control unit 28. The remote control decoder 60 provides an input to the interaction module 40 to indicate the channel to which the user 4 is tuned. The interaction module 40 provides a signal which is interpreted by a content processor 80. The content processor 80 may receive signals from the interaction module 40 via a network 70. In the present illustration, the network 70 comprises the Internet. The content processor contains components for interpreting data, following rules to make decisions based on data, obtain further information based on the data, and send information back to the interaction module 40. The interaction module 40 further comprises a GUI generator 64, which translates results received from operation of the content processor 80, further described below, to the video display 20.

In the content processor 80, a data bus 82 communicates with a first rules-based processor 84, a text decoder 86, content analyzer 88, a user profile memory 90, a data register 92, and a second rules-based processor 94. A request processor 96 may send commands back to the network 70 in order to request further data from external networks 100. The external networks 100 may comprise search engines and other data sources.

The first rules-based processor 84 contains rules for selecting terms from the content included in the signal CC. The text decoder 86 derives intelligence from the signal CC. The content analyzer 88 performs context searching in order to derive terms for use by the first and second rules based processors 84 and 94. The user profile memory 90 contains demographic details and preferences of the user 4. The data register 92 stores data to provide input data and store results from processing operations. The second rules-based processor 94 translates the data provided from the first rules-based processor 84, namely significant data, into search request terms. The request processor 96 translates the search request terms into queries that can be set by the Internet, 70 to the external networks 100. The request processor 96 may also be used to evaluate and select search results for provision to the GUI generator 64. The above-described components of content processor 80 are illustrated as discrete modules only for explanatory purposes. Generally, the content processor 80 will comprise an integrated circuit having various locations performing the functions described above.

As further described below, the user 4 may interface with the content processor 80 to provide information to the user profile memory 90. The user profile memory 90 will provide information to the content analyzer 88 to enable the request processor 96 to receive information that is sent back to the cable box 16 via the interaction module 40 and presented to the user 4. The user 4 may use the remote control 28 to further interact via the cable box 16 with the information provided from the request processor 96 by the content processor 80. A service company 110 may operate the content processor 80 and provide rules to the first and second rules based processors 84 and 94. The user profile memory 90 may contain preferences of the user 4 and data regarding the user 4 so that selections to be provided are tailored to the user 4. The user 4 may transmit preferences to the service company 110 or the user profile memory 90 directly via the Internet 70 from a personal computer 114.

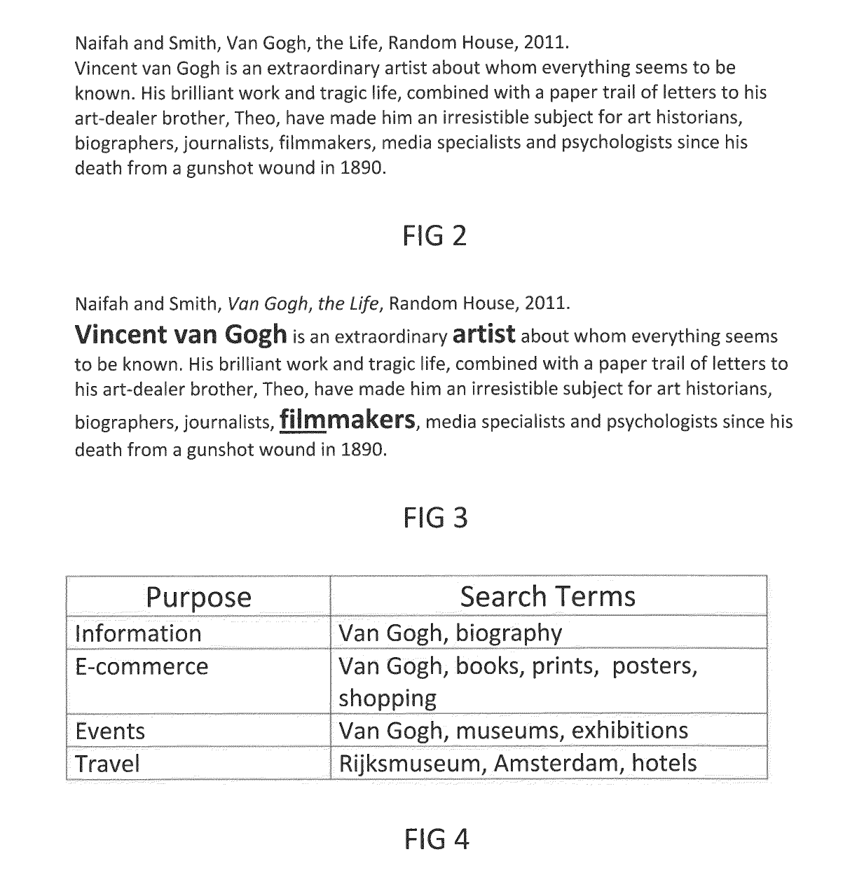

FIG. 2 is an illustration of a stream of text included in a nominal closed captioning data stream. For example, a program could include a review of Naifah and Smith, Van Gogh, the Life, Random House, 2011. A review from the Los Angeles Times said, “Vincent van Gogh is an extraordinary artist about whom everything seems to be known. His brilliant work and tragic life, combined with a paper trail of letters to his art-dealer brother, Theo, have made him an irresistible subject for art historians, biographers, journalists, filmmakers, media specialists and psychologists since his death from a gunshot wound in 1890.” This text would appear in the closed captioning transcript of a television signal including a narrator reading this passage.

FIG. 3 is an illustration of terms selected from the content in FIG. 2. A number of different strategies may be used in order to select terms that will be used in the method steps. For example, a rules based processor may select the name “Vincent van Gogh.” This term is indicated as being a selected term by its emphasis in FIG. 3. Another term that could be selected is “artist” Additionally, terms such as “filmmakers” can be used to derive terms such as “films.”

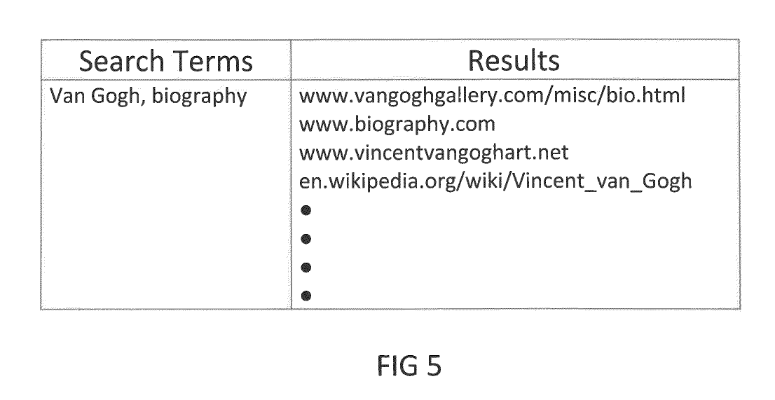

FIG. 4 is a chart illustrating searching that may be performed on the data illustrated in FIG. 3. Search targets may be selected based on one or more objectives. For educational purposes, “Vincent van Gogh” and “biography” could be used to search for biographical information. For e-commerce, “Vincent van Gogh” could be used as a search term to find online marketplaces for books, movies, and reproduction prints. The search term could also be used to search for upcoming exhibitions featuring van Gogh or to identify museums with significant collections. The commercial search purposes can be extended. For example, a search would indicate a significant collection at the Rijksmuseum in Amsterdam, the Netherlands. The search could be arranged to seek travel packages to Amsterdam.

FIG. 5 is a chart illustrating choices that may be provided to a user based on data obtained in response to searching. For example, FIG. 5 illustrates URLs for biographical data that has been returned by a search. Results may be provided in the same manner for each set of the search terms illustrated in FIG. 4. In FIG. 5, the first four results are set out in full. The dots below the first four results are set out to demonstrate that a large number of results may be obtained. The request processor 80 (FIG. 1) may select a particular number of results to provide to a rules based processor.

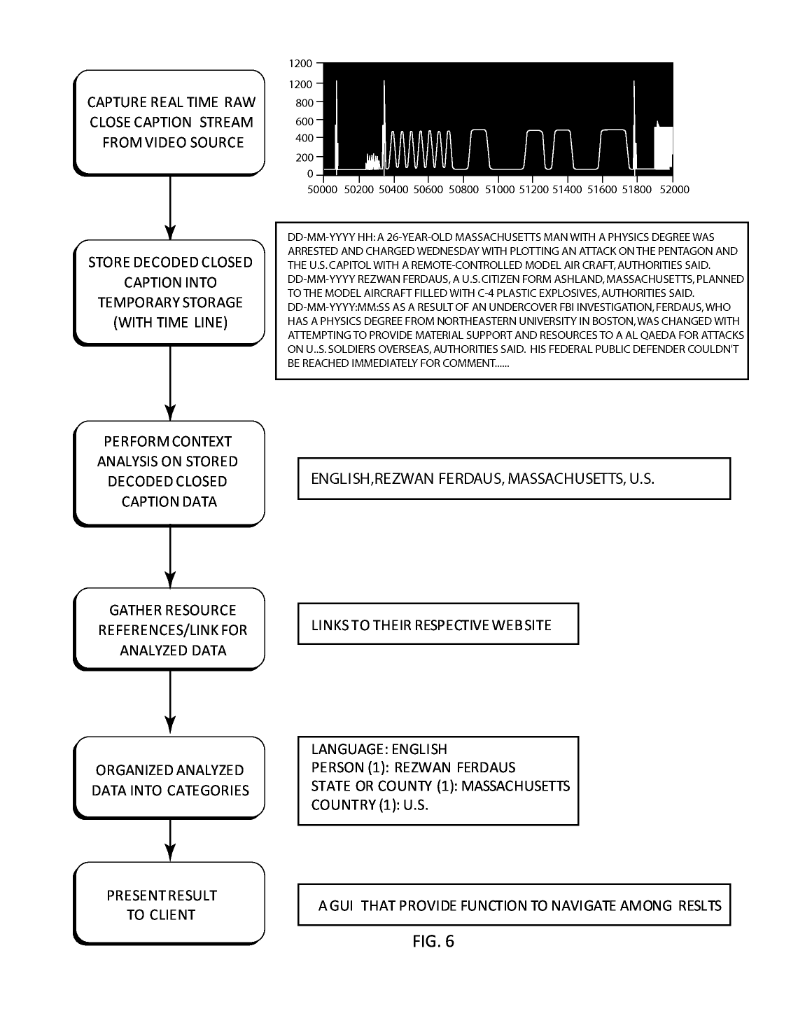

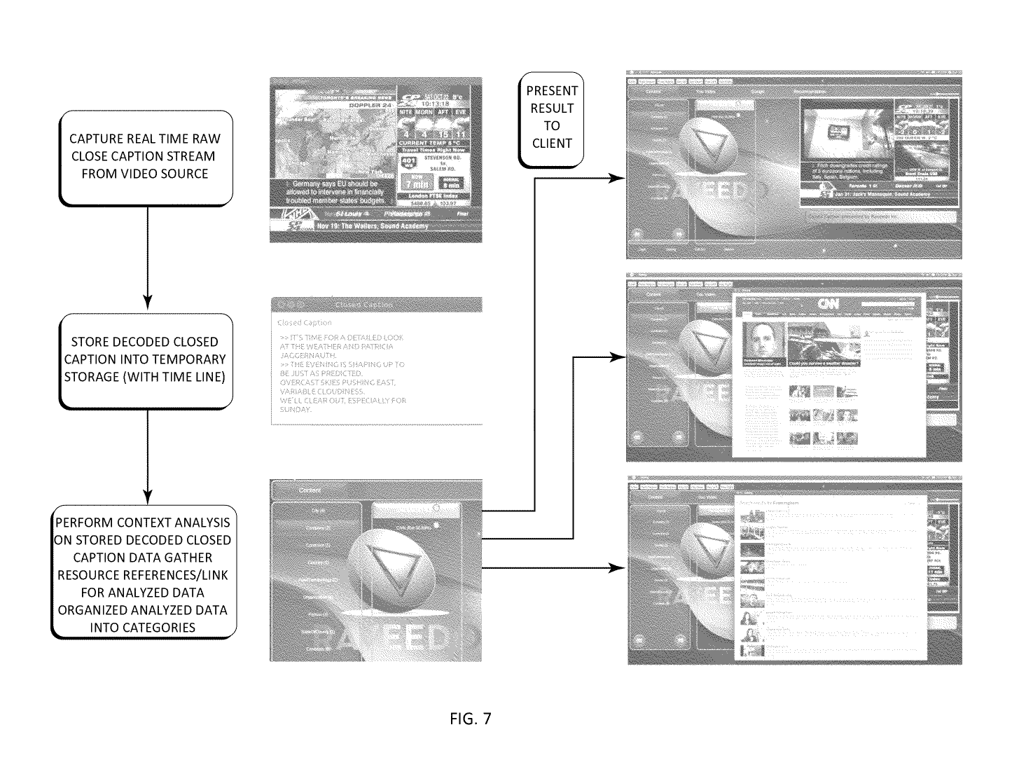

FIG. 6 is a diagram summarizing the complete concept of extracting context from the closed caption data and presenting the relevant results to the user. In FIG. 7, the GUI is illustrated including the list of choices provided along with instructions on the screen to the user 4. Each choice is contained in an option box 190 within the graphical user interface 24. The user 4 employs the remote control unit 20 in order to select the link displayed in one of the option boxes 190. Once the user 4 has made a selection, the GUI 24 displays a response.

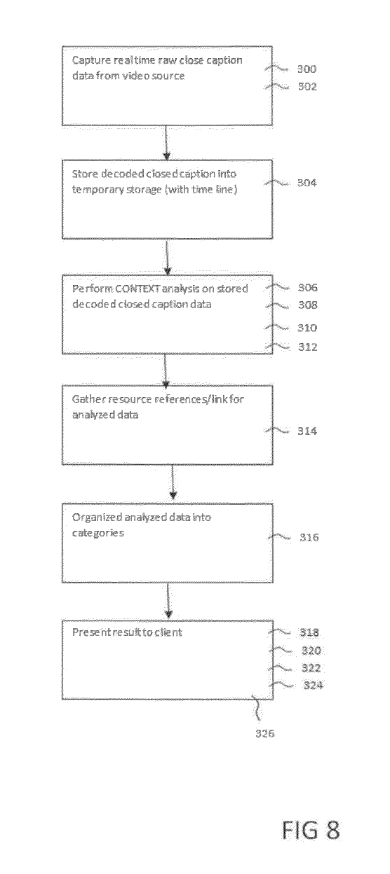

FIG. 8 is a flowchart illustrating operation of the content processor in the system of FIG. 1. At block 300, a selected channel of closed captioning information is provided to the content processor 70. The text parser 76 extracts the closed captioning data from the signal stream at block 302 and decodes data embodied therein at block 304. The data is provided to the content analyzer 78 and compared to criteria set in the user profile memory 80, at block 306. At block 308, the result of rules in the processor 70 provide search terms. At block 310, the terms are sent to the request processor 86. At block 312 the search processor 96 requests signals via the network 70 from the external network 100. At block 314 results are received at the request processor 96. At block 316 the request results are further compared to rules in the first request processor 84. The selected results are provided to a graphical user interface register at block 318. The system is allowed to respond at block 320 to inputs provided by the user 4. At block 322 the response provided to the cable box 18 by the user 4 is coupled to local storage in order to invoke a response. At block 324 the system confirms the selection to the user 4 in a display. If there is another level of selection required, operation returns to block 322. A next query is displayed to the user 4, and another response is made. Once the user 4 has completed selections, a final, display is made at block 326. The user 4 may provide a signal to positively terminate the interaction, or the system may provide the option to terminate the transaction mode after a “timeout” period.

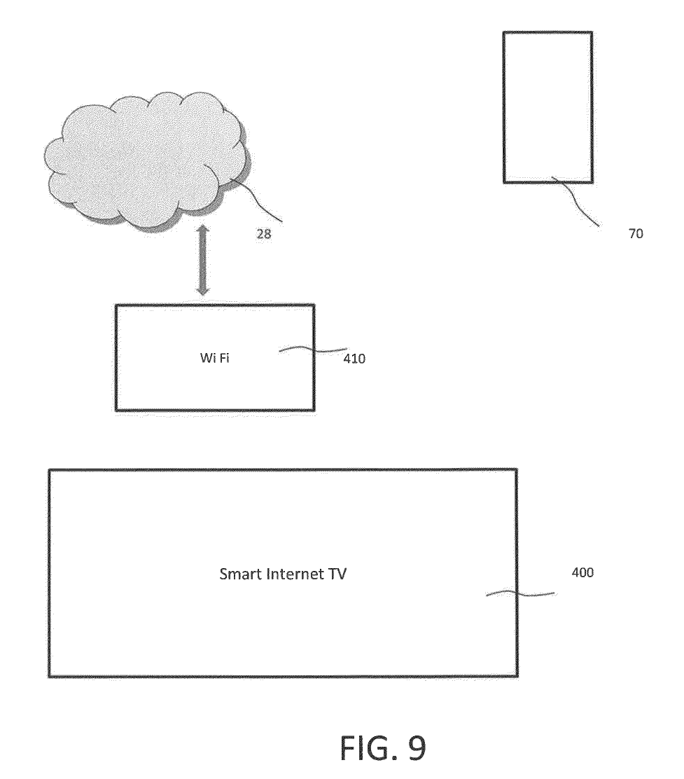

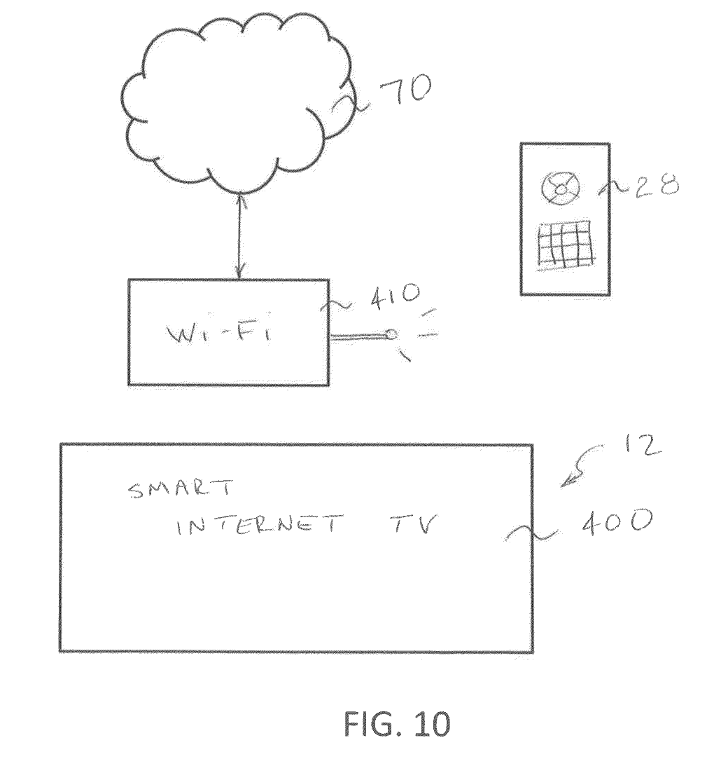

FIG. 9 is a block diagram illustrating a further implementation of the present subject matter. In this embodiment, the media device 12 comprises an Internet television 400 receiving streaming signals via the Internet 70. The Internet television 400 may comprise a “smart television,” which may run applications for facilitating interaction within the present system. The Internet television 400 may be coupled to the Internet 70 via a Wi-Fi interface 410. The remote control device 28 may be provided in a form for interaction with the Internet television 400. The Internet television 400 embodies a translation “app” for translating search results into signals viewable on a display.

In this manner, a great deal of flexibility may be provided in enriching the media experience for user 4. The present system may greatly enhance educational capabilities that can be provided by a program. Additionally, expanded and varied e-commerce opportunities are provided.

While the foregoing written description of the present subject matter enables one of ordinary skill to make and use what is considered presently to be the best mode thereof, those of ordinary skill will understand and appreciate the existence of variations, combinations, and equivalents of the specific embodiment, method, and examples herein. The present subject matter should therefore not be limited by the above described embodiment, method, and examples, but by all embodiments and methods within the scope and spirit of the present subject matter.

1. A method for providing program-related information to a smart television based on a closed caption data stream included in a television transmission, which data stream is indicative of program information, the method comprising the steps of:
receiving a television transmission signal containing the closed caption data stream;
extracting closed caption data from the closed caption data stream;
processing the closed caption data to derive the program information;
deriving a multi-dimensional entity search term from the program information in a rules-based content processor using a context creator;
establishing a plurality of targets, each target corresponding to a subset of results to be obtained based on the search term;
constructing a search query comprising the multi-dimensional entity search term;
transmitting the search query to an external network;
receiving search results;
ordering search results into groups using context aware information, each group corresponding to a target; and
providing groups of results to the smart television, each group corresponding to a target.

2. A method according to claim 1 wherein the step of providing groups of search results comprises providing a translation app running on the smart television and translating the selected search results into a display in a graphical user interface on a screen of the smart television, the graphical user interface comprising a plurality of sections, each section corresponding to one target.

3. A method according to claim 1 wherein the step of selecting search results comprises providing a memory and a rules-based request processor, providing the search results to the rules-based request processor, providing selected search results in accordance with rules set in the rules-based request processor, and ordering the results into groups, each group corresponding to a target.

4. A method according to claim 3 wherein the step of processing the closed caption data comprises decoding a closed captioning signal stream and performing a context search of the decoded closed captioning signal.

5. A method according to claim 4 wherein the step of establishing a plurality of targets comprises selecting at least one target based on data from a user profile.

6. A method according to claim 5 wherein the step of providing selected search results to the smart television further comprises providing a remote control and receiving at the smart television a control signal from the remote control indicative of a selected group.

7. A method according to claim 6 wherein the step of providing selected search results further comprises selecting a result within the selected group and accessing a link corresponding to the selected result.

8. A method according to claim 4 wherein the step of providing the selected search results to the smart television further comprises providing a control and receiving at the smart television a control signal from the control indicative of a selected group.

9. A method for providing program-related information to a media device based on a closed caption data stream included in a video transmission, which data stream is indicative of program information, the method comprising the steps of:
receiving a video transmission signal containing the closed caption data stream;
extracting the closed caption data from the closed caption data stream;
processing the closed caption data to derive the program information;
deriving a multi-dimensional entity search term from the program information in a rules-based content processor using a context creator;
establishing a plurality of targets, each target corresponding to a subset of results corresponding to the search term;
constructing a search query comprising the multi-dimensional entity search term;
transmitting the search terms to an external network;
receiving search results; and
ordering search results into respective groups using context aware information, each group corresponding to a target.

10. A method according to claim 9 further comprising the step of displaying the groups on a graphical user interface, each group appearing in a section of the graphical user interface.

11. A method according to claim 10 further comprising providing a control unit interacting with the graphical user interface and producing a signal in the control unit and transmitting the signal to select one result appearing on the graphical user interface.

12. A system for providing program-related information to a media device based on a closed caption data stream included in a video transmission, which data stream is indicative of program information comprising:
a data stream decoder;
a signal parser extracting the program data from the closed captioning data stream decoder;
a processor provided with a set of rules to select program information from the program data;
a rules-based content processor for deriving a search term from the program information;
a processor storing a plurality of targets, establishing a plurality of targets, each target corresponding to a subset of results to be obtained based on the search term;
a controller for transmitting the search terms to an external network and receiving search results; and
a rules-based request processor for selecting search results and ordering the results into corresponding groups, each group corresponding to a target.

13. A system according to claim 12, further comprising a remote control unit coupled to communicate with a graphical user interface, and further comprising means for making a selection of one search term and multiple targets in association with the one search term and providing a corresponding display.

14. A system according to claim 13 further comprising the graphical user interface, wherein the graphical user interface comprises means for providing displayed results and segregating the displayed results by categories corresponding to the targets.
